(19) United States
(12) Patent Application Publication
(10) Pub. No.: US 2011/0206022 A1
(43) Pub. Date: Aug. 25, 2011

(54) QoS WIRELESS NETWORKING FOR HOME ENTERTAINMENT

(75) Inventors: Anthony J. Grewe, Fogelsville, PA (US); Eric N. Klings, Freehold, NJ (US); Edwin A. Muth, Aberdeen, NJ (US)

(73) Assignee: AGERE SYSTEMS INC., Allentown, PA (US)

(21) Appl. No.: 12/809,736

(22) PCT Filed: Dec. 28, 2007
(86) PCT No.: PCT/US07/89025

§ 371 Date: Sep. 14, 2010

(51) Int. Cl. H04W 40/00; G06F 11/14

(52) U.S. Cl. 370/338; 714/749; 714/E11.141

(57) ABSTRACT

A layer above the MAC and PHY layers of a wireless network employs a forward error correction (FEC) protocol extension with selective acknowledgement to reduce the likelihood of retries to enhance performance in, for example, home entertainment networking applications. In addition, certain system parameters of the wireless network are controlled so as to either i) align required bandwidth with particular sustainable channel parameters of the wireless network, or ii) modify the channel characteristics. One or more of three mitigation techniques might be employed with the FEC protocol extension to enhance maintenance of radio communication in the wireless network: Physical-layer Rate Adaptation, Dynamic Interference Avoidance, and Media-encoding Layer Adaptation.

### BACKGROUND OF THE INVENTION

1. Field of the Invention

The present invention relates to wireless networking and, in particular, packet-based wireless communication systems for home entertainment.

2. Description of the Related Art

Home entertainment products that allow for video and/or audio entertainment must provide superior user experience in order to be successful. To a user, performance of the product should be transparent regardless of whether the equipment is networked through a wired or a wireless connection. However, an analog wired connection can transport data almost instantaneously, while a wireless connection incorporates many data manipulations. For example, the wireless connection incorporates analog-to-digital conversion(s) and vice-versa; encoding and decoding; packetizing and de-packetizing, and transmitting and receiving. In addition, as part of this digital processing, many of these data manipulations require buffering.

These data manipulations take time to implement, and, consequently, add delay in the data transmission path. Home entertainment products, however, have strict timing requirements for play-out of the data for video and/or audio content. The overall delay in wireless home entertainment product networking can cause violations on the strict timing requirements for play-out. Missing video frames can cause jerkiness and flashing screens; missing audio data can cause cracks, interruptions, or other audible artifacts.

For wireless networks, situations can occur during which radio communication is difficult to maintain, especially when there is relatively high interference noise causing relatively high bit error rates for the channel. For example, an IEEE 802.11 network, or even a cordless telephone handset, might be operating on the same channel as a co-located wireless home entertainment network also employing a version of the IEEE 802.11 standards. Consequently, even though a wireless protocol might employ data correction methods, such as Viterbi coding, wireless transport of data is inherently less reliable when compared to wire-based networks due to noise and other losses from the transmission channel characteristics. Thus, the residual error rate is relatively high for wireless networking systems such as those conforming to one of the family of IEEE 802.11 standards (e.g., an IEEE 802.11 network operating in accordance with 802.11a or 802.11g standard) or one of the family of IEEE 802.16 standards.

The typical frame error rate for wireless data transfer is on the order of 10⁻⁵, while for wired systems the error rate is on the order of 10⁻⁷. To account for this higher frame error rate, 802.11 standards employ a retry mechanism as part of its packet-based protocol: when a frame has not been correctly received, the frame is immediately retried. The 802.11 protocol is much more efficient for data transfer when large frames are used. For example, with 1000-Byte frames and a 24 Mbit/s bit rate, the efficiency of the protocol is 85%. Increasing the frame size to 2300 Bytes raises the efficiency to 93%. The disadvantage of the retry mechanism is that while it improves the reliability, it also increases system-level latency and jitter when retransmission of larger frame sizes is required. Another disadvantage of using large frames is that, in the normal operation of the IEEE 802.11 protocol, the entire frame is resent when an error is detected, wasting bandwidth and increasing play-out delay.

However, some techniques have been proposed that allow for modifications to long packets generated at the MAC level. For example, U.S. patent Ser. No. 10/746,153 to Gerritt W. Hiddink et al. entitled “Packet Sub-frame Structure for Selective Acknowledgement” filed on Dec. 24, 2003, describes techniques that divide a large MAC-level frame into sub-frames, and uses selective acknowledgement of the sub-frames to prevent re-transmission of the entire frame. Unfortunately, while these techniques have been proposed, they are as yet not accepted into the 802.11 family of standards, and, even if adopted, would not allow devices operating in accordance with earlier adopted standards, such as 802.11a, 802.11b, and 802.11g, to use the larger frame/sub-frame structure with selective acknowledgement.

To address some applications where higher levels of service are required, packet networks have introduced Quality of Service (QoS) specifications that allow system provisioning to dedicate higher or guaranteed amounts of bandwidth to certain packet streams. In addition, QoS provisioning allows for lesser or guaranteed maximum delay for certain packet streams. Such QoS techniques are known and described in, for example, the protocol extensions for IEEE 802.11e and IEEE 802.11h standards as well as, to some extent, in the IEEE 802.16 standards. For example, U.S. patent Ser. No. 10/706,724 to Sean Anthony Ramprashad entitled “Media Delivery Using Quality of Service Differentiation Within a Media Stream” filed on Nov. 12, 2003, describes techniques that employ QoS parameters for selective delivery of media content.

The OSI, or Open System Interconnection, model defines a networking framework for implementing protocols in seven layers. Control is passed from one layer to the next, starting at the application layer in one station, passing to the bottom layer, over the channel to the next station and back up the hierarchy to the application layer at the receiver. The protocol extensions for these QoS techniques are specified for the Medium Access Control (MAC) layer (part of the Data Link layer along with the Logic Link layer) and Physical (PHY) layer of the OSI model for the IEEE 802.11e/h and 802.16 standards. As described, home entertainment applications require strict timing requirements for play-out of the data for video and/or audio content. Unfortunately, these protocol extensions for these QoS techniques for the IEEE 802.11e/h and 802.16 standards are insufficient to provide superior user experience for home entertainment applications as they do not adequately address the strict timing requirements for play-out of the data for video and/or audio content.

### SUMMARY OF THE INVENTION

In one embodiment, the present invention is embodied in a data packet frame representing a sequence of bits of latency-constrained data, the data packet frame comprising: a header with source and destination information formed in accordance with packetization by a Media Access Control (MAC) layer; and one or more sub-frames, each sub-frame comprising payload data and a check value. The payload data of each sub-frame is a forward error correction (FEC)-encoded portion of the sequence of bits of latency-constrained data, and the one or more sub-frames are derived prior to packetization by the MAC layer.

In another embodiment, the present invention is embodied in data processing at a transmitter that a) partitions a sequence of latency-constrained data into one or more payload data portions; b) applies forward error correction encoding to each payload data portion prior to transfer to a Media Access Control (MAC) layer; c) transfers to the MAC layer the one or more FEC-encoded payload data portions; and d) then forms a packet frame from the one or more FEC-encoded payload data portions in accordance with packetization by the MAC layer.

In yet another embodiment, the present invention is embodied in data processing at a receiver that: a) receives a packet frame having one or more FEC-encoded payload data portions, wherein the packet frame represents latency-constrained data; b) determines whether each FEC-encoded payload data portion contains at least one error, and, if the FEC-encoded payload data portion contains at least one error, then: c) applies an FEC algorithm to each FEC-encoded payload data portion containing at least one error.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary format for an IEEE 802.11 frame employing forward error correction by a Medium Transport Control layer in accordance with an exemplary embodiment of the present invention;

FIG. 2 shows a method of processing by the Medium Transport Control layer at a transmitter in accordance with an exemplary embodiment of the present invention; and

FIG. 3 shows a method of processing by the Medium Transport Control layer at a receiver in accordance with an exemplary embodiment of the present invention.

### DETAILED DESCRIPTION

In accordance with exemplary embodiments of the present invention, a layer above the MAC and PHY layers of a wireless network (e.g., a home entertainment wireless network operating in accordance with an IEEE 802.11 or IEEE 802.16 standard) employs a forward error correction (FEC) protocol extension with selective acknowledgement. The forward error correction (FEC) protocol extension with selective acknowledgement reduces the likelihood of retries to enable, for example, strict timing requirements for play-out of the data for video and/or audio content without modifications to an existing IEEE 802.11 or IEEE 802.16 standard.

Such layer above the MAC layer might be, for example, the Logical Link Control layer (LLC) of the Data Link layer or the Transport layer of the OSI model known in the art. As employed herein, the term “Medium Transport Control (MTC) layer” refers to a layer in the OSI model performing techniques described herein in accordance with the exemplary embodiments of the present invention to provide enhanced performance for wireless networking with strict timing requirements for play-out of data. As employed herein, the term “latency-constrained data” refers to a data sequence having strict timing requirements for play out of the data sequence by a receiver.

In addition, some embodiments of the present invention control certain system parameters so as to either i) align required bandwidth with particular sustainable channel parameters of the wireless network, or ii) modify the channel characteristics. Three mitigation techniques are described herein to enhance maintenance of radio communication in the wireless network: physical layer (PHY) rate adaptation (PRA), Dynamic Interference Avoidance (DIA), and media-encoding layer adaptation (MEA).

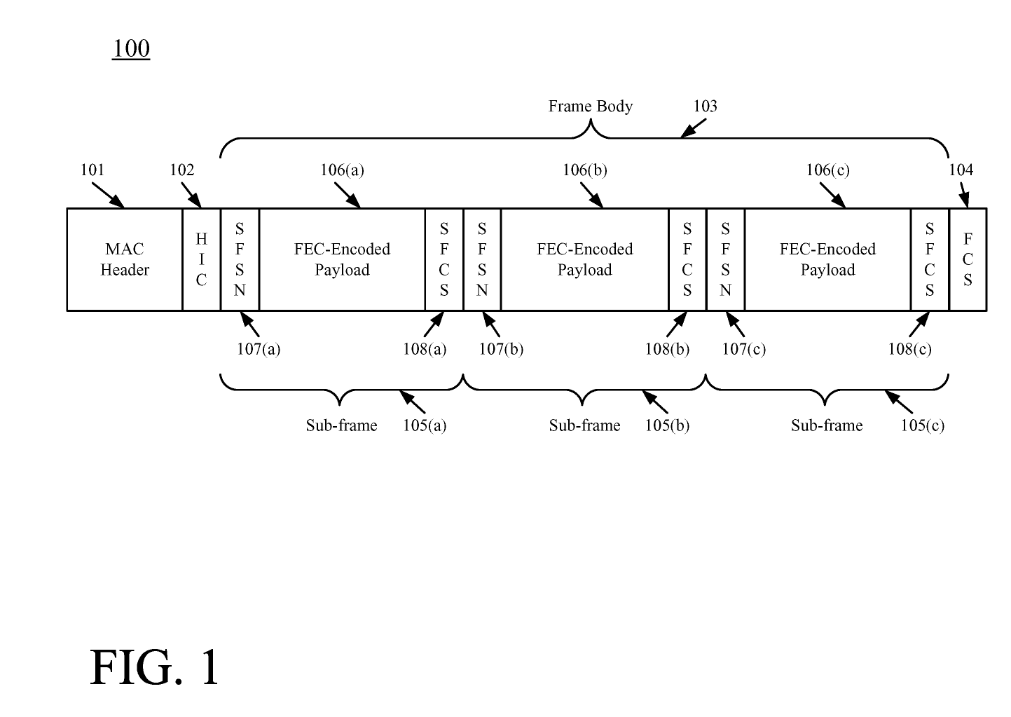

For example, a wireless home entertainment network operating in accordance with an IEEE 802.11 (or IEEE 802.16) standard employs the FEC protocol extension with selective acknowledgement either alone or in combination with one or more of the three mitigation techniques to provide enhanced system performance. FIG. 1 shows an exemplary format for an IEEE 802.11 frame 100 employing FEC in accordance with an exemplary embodiment of the present invention that a transmitter might send to a receiver.

Frame 100 comprises MAC header 101, header integrity check (HIC) 102, frame body 103, and Frame Check Sequence (FCS) 104. MAC header 101 contains packet header information such as, but not limited to, source and destination information, packet format type (e.g., 802.11 version), and synchronization information. HIC 102 is a checksum value computed over MAC header 101 to indicate to a receiver that MAC header 101 is received correctly. Frame body 103 comprises FEC-encoded user data by the MTC layer, such as MPEG-formatted video/audio data. FCS 104 is a checksum value computed over MAC header 101, HIC 102, and frame body 103 to indicate to a receiver that frame 100 is received correctly.

The IEEE 802.11 protocol provides the best efficiency when using large frames. Sub-frame selective acknowledgement partitions an IEEE 802.11 frame into a number (e.g., 15-20) of smaller sub-frames, allowing the MTC layer of the receiver to request retransmission of only those sub-frames that have been damaged. Thus, frame body 103 comprises sub-frames 105(a), 105(b), and 105(c). Sub-frames 105(a), 105(b), and 105(c), respectively, comprise corresponding FEC-encoded payloads 106(a), 106(b), and 106(c) with i) sub-frame sequence numbers (SFSNs) 107(a), 107(b), and 107(c); and ii) sub-frame check sequences (SFCSs) 108(a), 108(b), and 108(c). SFSNs 107(a), 107(b), and 107(c) identify, to a receiver, a particular one of encoded payloads 106(a), 106(b), and 106(c). SFCSs 108(a), 108(b), and 108(c) identify, to a receiver, whether a particular one of corresponding encoded payloads 106(a), 106(b), and 106(c) contains one or more errors through, for example, a parity, checksum or CRC calculation. While the exemplary frame 100 of FIG. 1 is shown with three sub-frames 105(a), 105(b), and 105(c), frame 100 might comprise one or more sub-frames as supported by the IEEE 802.11 standard.

FEC encoding applied to FEC-encoded payload 106(a), 106(b), and 106(c) adds a level of redundant information to the data stream, enabling the receiver to identify and repair a number of errors without requesting a retransmission of entire packet frame 100. At a receiver, when errors are present in an FEC-encoded payload, the receiver detects and corrects errors in the FEC-encoded payload. The receiver might also employ selective acknowledgement if the number of errors detected in an FEC-encoded payload exceeds the ability of the FEC algorithm to correct the errors. If the FEC algorithm is unable to correct the errors, then the receiver communicates to the MTC layer of the transmitter, via a reverse channel, the SFSN of each sub-frame that cannot be corrected. The MTC layer of the transmitter then causes only the data of the FEC-encoded payload corresponding to that SFSN to be retransmitted. Consequently, the effective residual error rate is reduced without significant latency or jitter penalty.

To accommodate for burst errors that would destroy too many consecutive or closely spaced bits in a sequence, an interleaved coding scheme might be employed in conjunction with any number of FEC error detection/correction techniques known in the art. Algorithms for such FEC encoding of FEC-encoded payload 106(a), 106(b), and 106(c) include i) convolutional coding, such as Viterbi, punctured, and turbo coding, and ii) block coding, such as Reed-Solomon, Golay, BCH, and Hamming block coding. Since IEEE 802.11e QoS extensions do not define an FEC mechanism, the exemplary embodiment described herein uses block interleaving by the MTC layer as an overlay to the FEC-encoded payload to reduce burst error effects without incurring modifications to any current IEEE 802.11 standard.

In addition to FEC, the MTC layer might employ one or more of the following three mitigation techniques, PRA, DIA, and MEA, to enhance maintenance of radio communication in the wireless network.

PRA operates as follows. The PHY rate is the bit rate at which the radio modem is transmitting data, and the PHY bit rate depends on the modulation technique and coding rate employed. For example, the IEEE 802.11g extension allows bit rates of 36 Mbit/s, 48 Mbit/s, 54 Mbit/s, and higher. Each bit rate, (defined by a combination of modulation type and coding rate) has its own specific robustness properties. For example, some modulations are more robust against multipath interference, while others are more robust against inter-symbol interference, and still others just lower the signal level to provide a certain level of reliability. In PRA, a wireless system selects a modulation type and coding rate that best fits the current radio communication channel properties.

DIA operates as follows. When the MTC layer determines that, for example, FEC and PRA do not provide sufficient transmission performance improvement (due to, e.g., a too strong of an external interferer or other noise source), then the MTC layer selects a different transmission channel (e.g., a different transmission band). DIA employs coordination between the nodes of the network to make sure that no node is left behind on the previous channel without knowing what the new channel is. The IEEE 802.11h protocol extensions provide such a DIA mechanism specifically designed to avoid channels in the 5 GHz band in which radar systems are active.

MEA operates as follows. When the MTC layer determines that, for example, FEC in combination with PRA and/or DIA do not provide sufficient transmission performance improvement, the MTC layer then adapts the encoding of the media for transmission. For audio applications, PRA and/or DIA might provide sufficient performance, but in particularly poor environments the audio encoding rate might also be changed. Video applications might generally require either adaptation of the media encoding parameters, data partitioning, frame skipping, and/or error concealment to provide sufficient transmission performance improvement.

For adaptation of media encoding parameters, if the channel is unable to sustain the required throughput, then the MTC layer might adaptively set the media encoding rate. For example an MPEG video/audio encoding rate might be changed or the ratio of I/P/B frames that the MPEG encoder is generating might be modified to lower the average bit rate.

For media data partitioning, the data can be partitioned into layers with each layer having a different set of reliability requirements, so that a “basic set” of data might be sent with very high reliability, while “enhancement data sets” might be sent with differing reliability levels so that additional layers of quality are provided if sufficient resources are available (bandwidth, processing power, memory, etc). Thus, a graceful degradation of the system's functionality is achieved under poor network operating conditions. Such data partitioning mechanisms might include (1) selectively dropping data from transmit buffers at the source side if the bandwidth is insufficient; (2) using alternative media access parameters in a MAC layer controller so that the base layer data has a higher chance of arriving at the receive side. For audio, for example, LEFT+RIGHT audio might be used as the base layer and LEFT−RIGHT might be used as an enhancement layer. In case of bad channel conditions, the “fallback” mode for audio would be a mono representation. For MPEG video, the DCT coefficients might also be partitioned into differing levels of importance.

Since errors in the data stream result in errors in a picture, these errors might either be i) concealed through any number of well-known techniques or ii) by frame skipping if the number of error exceeds a threshold and the corresponding video frame is too distorted. In such a case, the previous video frame might be repeated, and the distorted one omitted, or a new frame interpolated from the previous and subsequent video frames.

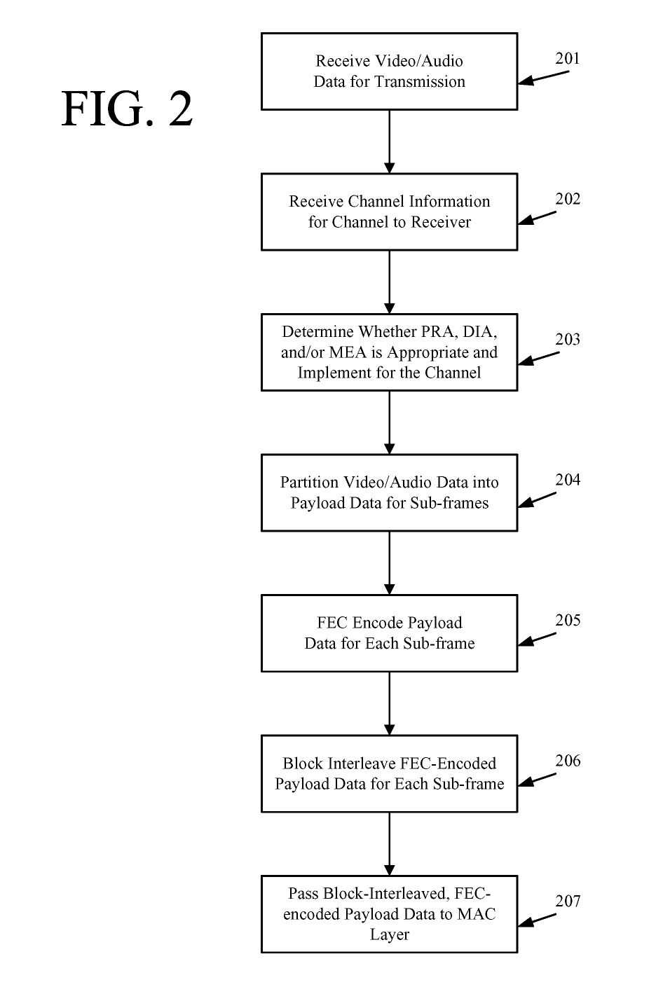

FIG. 2 shows a method of processing by an MTC layer at a transmitter in accordance with an exemplary embodiment of the present invention. At step 201, the MTC layer receives video/audio data for transmission. At step 202, the MTC layer receives channel information regarding a general quality of the transmission channel to the receiver, if known. Such channel information might comprise the number of re-transmissions for frames and/or sub-frames from the MAC layer, measured bit error rate, delay, or similar information measured and communicated back to the transmitter by the receiver. Based on such channel information, at step 203, the MTC layer makes a determination of whether one or more of PRA, DIA, and MEA techniques might be required for continued transmission. Such determination of PRA and DIA is communicated to the MAC and PHY layers, while a determination of MEA is processed directly at the MTC layer.

At step 204, the MTC layer partitions the video/audio data into payload data for each sub-frame at the MAC layer, and, at step 205, the partitioned video/audio data FEC encoded. At step 206, the FEC-encoded payload data for each sub-frame is optionally block interleaved. At step 207, the block-interleaved, FEC encoded payload data is passed to the MAC layer for packetizing and transmission by the PHY layer.

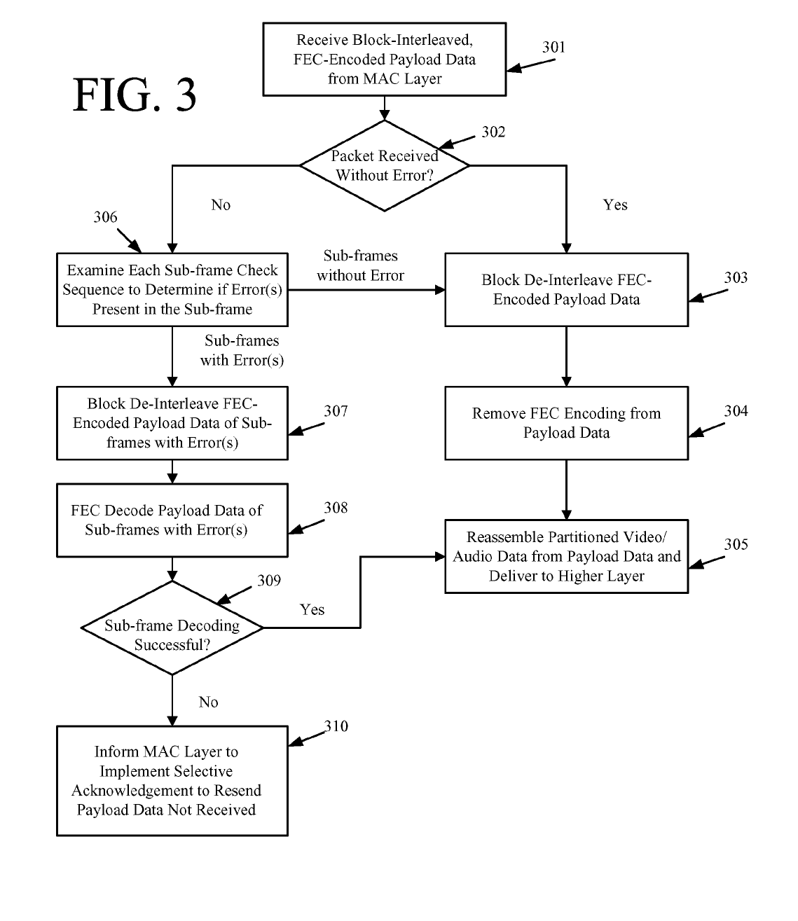

FIG. 3 shows a method of processing by an MTC layer at a receiver in accordance with an exemplary embodiment of the present invention. The method of FIG. 3 might be employed when receiving a frame such as frame 100 of FIG. 1. At step 301, the MTC layer at the receiver receives block interleaved, FEC-encoded payload data from the MAC layer. A test, at step 302, determines whether there is an indication that the corresponding frame carrying the block-interleaved, FEC-encoded payload data from the MAC layer was received with or without error. The indication is generated if, at a receiver, the MAC layer verifies from HIC 102 and FCS 104 (of FIG. 1) that the packet is received correctly, and, thus, no further action is necessary.

Consequently, if the test of step 302 determines that FEC-encoded payload data from the MAC layer was received without error, the MTC layer, at step 303, block de-interleaves the payload data of each sub-frame 105. At step 304, the MTC layer removes the FEC encoding to generate partitioned video/audio data, and, at step 305, the partitioned video/audio data is reassembled and delivered to higher layers of, for example, a home entertainment system.

If the test of step 302 determines that FEC-encoded payload data from the MAC layer was received with errors, then the MTC layer proceeds to step 306. At step 306, the MTC layer examines the sub-frame check sequence (e.g., SFCS 108) to determine if the corresponding sub-frame is in error. From step 306, those sub-frames received without error are passed to step 303 and those sub-frames received with error(s) are passed to step 307. At step 307, those sub-frames received with error(s) are block de-interleaved and, at step 308, FEC decoded to identify and repair, if possible, bit errors in the sub-frame. A test at step 309 determines, for each sub-frame received with error(s), if the encoded payload was successfully decoded. If the test of step 309 determines that the sub-frame was successfully decoded, then the payload is transferred to step 305. If the test of step 309 determines that the sub-frame was not successfully decoded, at step 310, then the MTC layer informs the MAC layer to implement selective acknowledgement to cause the transmitter to retransmit the data of the unsuccessfully received sub-frame payloads.

Although not shown in FIG. 3, the MTC layer of the receiver might monitor and otherwise measure channel information (BER, frame error rate, delay, or other channel characteristics) for communication back to the transmitter. In addition the MAC and PHY layers of the receiver respond to PRA and DIA commands from the corresponding MAC and PHY layers of the transmitter, while the MTC layer will provide video/audio data received as a result of the MEA techniques of the transmitter's MTC layer.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, microcontroller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

1-21. (canceled)

22. A method of data processing at a transmitter, comprising:
a) partitioning a sequence of latency-constrained data into two or more payload data portions;
b) applying forward error correction (FEC) encoding to each of said two or more payload data portions prior to transfer to a Media Access Control (MAC) layer;
c) transferring from a Medium Transport Control (MTC) layer to the MAC layer the two or more FEC-encoded payload data portions, wherein the MTC layer is above the MAC layer in an OSI model;
d) then forming a MAC packet frame, in accordance with packetization by the MAC layer and at least one of the IEEE 802.11 and IEEE 802.16 family of standards, from (i) the two or more transferred FEC-encoded payload data portions and (ii) a MAC header comprising source and destination information; and
e) wirelessly transmitting over a transmission channel a signal corresponding to the MAC packet frame.

23. The invention of claim 22, wherein step d) comprises block interleaving each FEC-encoded payload data portion.

24. The invention of claim 22, further comprising:
f) receiving channel information from a receiver of the signal; and
g) selecting at least one of physical layer (PHY) rate adaptation (PRA), Dynamic Interference Avoidance (DIA), and media-encoding layer adaptation (MEA) based on the channel information.

25. The invention of claim 22, wherein method is implemented in a wireless home entertainment network.

26. The invention of claim 22, further comprising:
receiving from an intended receiver a selective acknowledgment that identifies for retransmission a subset of said two or more transferred FEC-encoded payload data portions; and
retransmitting over the transmission channel a signal corresponding to the identified subset.

27. The invention of claim 22, wherein the MTC layer is a Logical Link Control (LLC) layer of the OSI model.

28. The invention of claim 22, wherein the MTC layer is a Transport layer of the OSI model.

29. The invention of claim 22, wherein the MAC packet frame comprises:
the MAC header;
a header-integrity-check (HIC) portion that indicates to an intended receiver of said MAC packet frame whether the MAC header is received correctly;
two or more sub-frames, each sub-frame comprising:
a corresponding sub-frame sequence number (SFSN) that identifies to the receiver a corresponding one of the transferred FEC-encoded payload data portions;
said corresponding one of the transferred FEC-encoded payload data portions; and
a corresponding check sequence that indicates to the receiver whether said corresponding one of the transferred FEC-encoded payload data portions has a transmission-induced error; and
a checksum computed over the MAC header, the HIC portion, and the two or more sub-frames.

30. The invention of claim 29, further comprising:
receiving from the receiver a selective acknowledgment that identifies for retransmission the SFSNs of a subset of said two or more sub-frames; and
retransmitting over the transmission channel a signal carrying the identified subset of sub-frames.

31. A method of data processing at a receiver, comprising:
a) wirelessly receiving a signal corresponding to a MAC packet frame that has been formed in accordance with packetization by a MAC layer and at least one of the IEEE 802.11 and IEEE 802.16 family of standards, wherein the MAC packet frame has (i) two or more FEC-encoded payload data portions and (ii) a MAC header comprising source and destination information, wherein the MAC packet frame represents latency-constrained data;
b) transferring from the MAC layer to a Medium Transport Control (MTC) layer the two or more FEC-encoded payload data portions, wherein the MTC layer is above the MAC layer in an OSI model;
c) determining whether the transferred FEC-encoded payload data portions contains at least one error, and, if the transferred FEC-encoded payload data portions contains at least one error, then:
d) applying an FEC algorithm to each transferred FEC-encoded payload data portion containing at least one error; and
e) if step d) does not correct each error in each FEC-encoded payload data portion containing at least one error, then sending to a transmitter of the signal a selective acknowledgment that identifies for retransmission a corresponding subset of payload data portions.

32. The invention of claim 31, further comprising providing the latency-constrained data.

33. The invention of claim 31, further comprising, if step c) determines that a transferred FEC-encoded payload data portion is correct, then removing the FEC encoding from the transferred FEC-encoded payload data portion to recover a corresponding portion of the latency-constrained data.

34. The invention of claim 31, further comprising block de-interleaving each FEC-encoded payload data portion.

35. The invention of claim 31, wherein method is implemented in a wireless home entertainment network.

36. The invention of claim 31, wherein the MTC layer is a Logical Link Control (LLC) layer of the OSI model.

37. The invention of claim 31, wherein the MTC layer is a Transport layer of the OSI model.

38. The invention of claim 31, wherein the MAC packet frame comprises:
the MAC header;
a header-integrity-check (HIC) portion that indicates to the receiver whether the MAC header is received correctly;
two or more sub-frames, each sub-frame comprising:
a corresponding sub-frame sequence number (SFSN) that identifies to the receiver a corresponding one of the transferred FEC-encoded payload data portions;
said corresponding one of the transferred FEC-encoded payload data portions; and
a corresponding check sequence that indicates to the receiver whether said corresponding one of the transferred FEC-encoded payload data portions has a transmission-induced error; and
a checksum computed over the MAC header, the HIC portion, and the two or more sub-frames.

39. The invention of claim 38, wherein the selective acknowledgment identifies for retransmission the SFSNs of a subset of said two or more sub-frames.
